(19) United States
(12) Patent Application Publication
(10) Pub. No.: US 2010/0067852 A1
(43) Pub. Date: Mar. 18, 2010

(54) METHOD FOR ASSEMBLING A FURRULE FOR AN OPTICAL WAVE GUIDE CONNECTOR, FERRULE, WAVE GUIDE RIBBON AND TOOL FOR ASSEMBLING THE FERRULE

(75) Inventors: Roger F. Dangel, Lussirainstrasse (CH); Folkert Horst, Wettingen (CH); Daniel S. Jubin, Langnau am Albis (CH); Tobias P. Lamprecht, Berneck (CH); Bert Jan Offrein, Schoenenberg (CH)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/556,708

(22) Filed: Sep. 10, 2009

(30) Foreign Application Priority Data
Sep. 18, 2008 (EP) 08105374.6

(51) Int. Cl. G02B 6/36; G02B 6/44; G02B 6/00

(52) U.S. Cl. 385/83; 385/114; 385/78; 385/134

(57) ABSTRACT

A method for assembling a ferrule for an optical wave guide connector, a ferrule for an optical wave guide connector, a wave guide ribbon and a tool for assembling the ferrule. The method includes aligning a first body of the ferrule with respect to an alignment body. The first body includes a longitudinal recess adapted to receive at least one wave guide ribbon. Each wave guide ribbon includes at least one optical wave guide. The method further includes aligning at least one wave guide ribbon with respect to the alignment body and inserting the at least one wave guide ribbon into the longitudinal recess of the first body. Lastly, the method further includes closing the longitudinal recess of the first body with a second body of the ferrule.

### CROSS-REFERENCE TO RELATED APPLICATIONS

This application claims priority under 35 U.S.C. §119 from European Patent Application No. 08105374.6 filed Sep. 18, 2008, the entire contents of which are incorporated herein by reference.

### TECHNICAL FIELD

The present invention relates to a method for assembling a ferrule for an optical wave guide connector, a ferrule for an optical wave guide connector, a wave guide ribbon with at least one optical wave guide and a tool for assembling a ferrule for an optical wave guide connector.

### BACKGROUND OF THE INVENTION

U.S. Pat. No. 5,937,128 discloses a wave guide connector and a method of forming a wave guide connector. The wave guide connector includes a topographic pattern and is placed over a transparent polymeric multilayer laminate and is pressed towards the polymeric multilayer laminate so that the topographic pattern in the wave guide connector stands out in relief in the laminate to form a wave guide pattern in the waveguide connector. The multilayer laminate is fixed in the wave guide connector after pressing.

U.S. Pat. No. 6,496,624 discloses an optical wave guide device for optical wiring and manufacturing and a method. A polymeric wave guide includes a film-shaped optical wave guide. A connector is formed by two connector parts with a polymeric wave guide loading groove for loading the polymeric wave guide. The polymeric wave guide is sandwiched between the two connector parts.

U.S. Pat. No. 6,695,488 discloses a tool and a method for forming a multi fiber ferrule. The multi fiber optical ferrule is formed of two ferrule halves which are either molded or cast as imprecise blanks which are machined using a broach in order to precisely cut inner surfaces thereof for receiving an array of fibers. The halves are joined together with a fiber array placed there between to form the ferrule.

U.S. Pat. No. 7,295,743 discloses an optical wave guide, an optical wave guide ferrule and an optical connector. The optical wave guide includes an optical wave guide core for transmitting optical signals, a plate-shaped clad portion containing the optical wave guide core therein, and at least one of a concave portion and a convex portion at an end surface portion of the clad portion. The end surface portion is disposed near one end of the optical wave guide core. The optical wave guide ferrule has an opening portion for receiving the optical wave guide and at least one of a convex portion and a convex portion having a concave portion on an inner surface thereof at one end of the opening portion. In the optical connector is inserted the optical wave guide in the opening portion of the optical wave guide ferrule.

U.S. Pat. No. 6,317,964 discloses a wave guide connector and a method and arrangement for aligning the wave guide connector to at least one optical device. The arrangement includes the wave guide connector and a substrate carrying at least one wave guide. The wave guide connector has both guide legs and aligning elements. The method includes the step of shaking the arrangement at a frequency and amplitude sufficient to cause opposing aligning elements disposed on the wave guide connector and on the substrate to engage each other.

U.S. Pat. No. 6,990,263 discloses a connector-integrated type polymer optical wave guide and a method and a mold for producing the same. A pair of connector sleeves are formed at positions at which the connector sleeves sandwich an optical wave guide core at least in one end portion of the polymer optical wave guide. A rigid member for connector formation is provided, wherein a film substrate for clad and the connector sleeves are fixed to the rigid member for connector formation in such a state that a center of the optical wave guide core and a center for connector sleeves are substantially on the same plane.

In Katsuki Suematsu, et al., “Super Low-Loss, Super High-Density Multi-Fiber Optical Connectors”, Furukawa Review, No. 23, 2003, pages 53 to 58, optical connectors with MT ferrules and a structure of a metal mold for manufacturing MT ferrules are disclosed. A pin holder with pins is used in the mold to manufacture holes in the ferrule for receiving optical fibers.

It is a challenge to provide (i) a method for assembling a ferrule for an optical wave guide connector that is simple and reliable, (ii) a ferrule for an optical wave guide connector enabling a simple and reliable assembly, (iii) a wave guide ribbon with at least one optical wave guide enabling simple and reliable assembly within a ferrule for an optical wave guide connector and (iv) a tool for assembling a ferrule for an optical wave guide connector enabling simple and reliable assembly of the ferrule.

### SUMMARY OF THE INVENTION

Accordingly, a first aspect of the invention provides a method for assembling a ferrule for an optical wave guide connector. The method includes aligning a first body of the ferrule with respect to an alignment body. The first body includes a longitudinal recess adapted to receive at least one wave guide ribbon. Each wave guide ribbon includes at least one optical wave guide. The method further includes aligning at least one wave guide ribbon with respect to the alignment body and inserting the at least one wave guide ribbon into the longitudinal recess of the first body. The method further includes closing the longitudinal recess of the first body with a second body of the ferrule.

A second aspect of the invention provides a ferrule for an optical wave guide connector. The ferrule includes a first body comprising a longitudinal recess adapted to receive at least one wave guide ribbon. Each wave guide ribbon includes at least one optical wave guide. The first body includes at least one body alignment element adapted to aligning the first body to an alignment body during an assembly of the ferrule. The ferrule includes a second body adapted to being arranged on the first body closing the longitudinal recess of the first body.

A third aspect of the invention provides a wave guide ribbon. The wave guide ribbon includes at least one optical wave guide arranged longitudinally in the wave guide ribbon. The wave guide ribbon further includes at least one body alignment element for aligning the wave guide ribbon to an alignment body during assembly of a ferrule for an optical wave guide connector. The at least one optical wave guide is arranged at a predetermined position with respect to the at least one body alignment element.

A fourth aspect of the invention provides a tool for assembling a ferrule for an optical wave guide connector is provided. The tool includes at least one alignment body with an assembly surface. The tool further includes at least one ferrule alignment element arranged on the assembly surface for aligning the ferrule with respect to the at least one alignment body. The tool further includes at least one ribbon alignment element arranged on the assembly surface for aligning at least one wave guide ribbon with respect to the at least one alignment body.

The advantage is that by aligning the first body and the at least one wave guide ribbon, respectively, with respect to the alignment body, the at least one wave guide ribbon can be aligned very precisely with respect to the first body of the ferrule without requiring that the first body and the at least one wave guide ribbon be manufactured with high accuracy to automatically align to each other. Particularly the first body and the at least one wave guide ribbon can thus be manufactured with low cost. It is particularly advantageous that two or more wave guide ribbons can be aligned to each other and with respect to the ferrule very precisely. A precision in the order of magnitude of ±5 μm or better can be achieved reliably. A further advantage is that the assembly is simple.

### BRIEF DESCRIPTION OF THE DRAWINGS

FIG. 1 shows a lateral cut through a stack of four wave guide ribbons;

FIG. 2 shows a top view of a tool for assembling two ferrules in parallel with ferrules according to a first embodiment and wave guide ribbons during assembly;

FIG. 3 shows a top view and side view of an embodiment of a part of the ferrule;

FIG. 4A shows a first lateral cut view of the first embodiment according to lateral cut ‘A’ of FIG. 2;

FIG. 4B shows a second lateral cut view of the first embodiment according to lateral cut ‘B’ of FIG. 2, with the part of the ferrule shown in FIG. 3 mounted additionally;

FIG. 4C shows a third lateral cut view of the first embodiment according to lateral cut ‘C’ of FIG. 2, with the part of the ferrule shown in FIG. 3 mounted additionally;

FIG. 5A shows a first exploded view of the tool, a second embodiment of the ferrule and the wave guide ribbon;

FIG. 5B shows a second exploded view of the tool, the second embodiment of the ferrule and the wave guide ribbon;

FIG. 6A shows a first lateral cut view of the second embodiment according to lateral cut ‘A’ of FIG. 2;

FIG. 6B shows a second lateral cut view of the second embodiment according to lateral cut ‘B’ of FIG. 2, with the part of the ferrule shown in FIGS. 5A and 5B mounted additionally;

FIG. 6C shows a third lateral cut view of the second embodiment according to lateral cut ‘C’ of FIG. 2, with the part of the ferrule shown in FIGS. 5A and 5B mounted additionally;

FIG. 7A shows a first part of a flow diagram; and

FIG. 7B shows a second part of the flow diagram.

### DETAILED DESCRIPTION OF THE PREFERRED EMBODIMENTS

The invention and its embodiments will be more fully appreciated by reference to the following detailed description of presently preferred but nonetheless illustrative embodiments when taken in conjunction with the accompanying drawings.

A first aspect of the invention provides a method for assembling a ferrule for an optical wave guide connector. The method includes aligning a first body of the ferrule with respect to an alignment body. The first body includes a longitudinal recess adapted to receive at least one wave guide ribbon. Each wave guide ribbon includes at least one optical wave guide. The method further includes aligning at least one wave guide ribbon with respect to the alignment body and inserting the at least one wave guide ribbon into the longitudinal recess of the first body. The method further includes closing the longitudinal recess of the first body with a second body of the ferrule.

The advantage is that by aligning the first body and the at least one wave guide ribbon, respectively, with respect to the alignment body, the at least one wave guide ribbon can be aligned very precisely with respect to the first body of the ferrule without requiring that the first body and the at least one wave guide ribbon be manufactured with high accuracy to automatically align to each other. Particularly, the first body and the at least one wave guide ribbon can thus be manufactured with low cost. It is particularly advantageous that two or more wave guide ribbons can be aligned to each other and with respect to the ferrule very precisely. A precision in the order of magnitude of ±5 μm or better can be achieved reliably. A further advantage is that the assembly is simple.

Preferably, the method also includes the step of cutting the wave guide ribbon at a front face of the ferrule. Preferably, the first and the second body of the ferrule are designed such that the at least one wave guide ribbon inserted into the longitudinal recess of the first body is fixed with respect to the ferrule between the first and the second body, for example by clamping. The second body is can be fixed to the first body, for example, with an adhesive.

According to a preferred embodiment, the alignment body includes at least one ferrule alignment element and the first body of the ferrule includes at least one corresponding body alignment element. The aligning of the first body of the ferrule to the alignment body includes bringing together the corresponding at least one ferrule alignment element and body alignment element. The advantage is that this is simple and that a very precise alignment is possible if the alignment elements are positioned precisely on the alignment body and the ferrule.

According to a further preferred embodiment, the alignment body includes at least one ribbon alignment element and the at least one wave guide ribbon includes at least one corresponding body alignment element. The aligning of the at least one wave guide ribbon to the alignment body includes bringing together the at least one ribbon alignment element and corresponding body alignment element. The advantage is that this is simple and that a very precise alignment is possible if alignment elements are positioned precisely on the alignment body and the wave guide ribbon.

According to a further preferred embodiment, at least two wave guide ribbons are inserted into the longitudinal recess of the first body directly above one another. The advantage is that this is simple and that this allows for a high precision of the positioning of the optical wave guides in a vertical direction with respect to an assembly surface if the wave guide ribbons are precisely manufactured with a predetermined thickness.

According to a further preferred embodiment, the aligning of the first body of the ferrule with respect to the alignment body includes arranging the first body on an assembly surface of the alignment body. Prior to inserting the at least one wave guide ribbon into the longitudinal recess of the first body, a spacer body is arranged on the assembly surface of the alignment body at a front face of the first body. The spacer body has a height equaling a height of the first body in the longitudinal recess with respect to the assembly surface of the alignment body. By this, a high precision is possible. The spacer body stabilizes the at least one wave guide ribbon outside of the ferrule.

A second aspect of the invention provides a ferrule for an optical wave guide connector. The ferrule includes a first body having a longitudinal recess adapted to receive at least one wave guide ribbon. Each wave guide ribbon includes at least one optical wave guide. The first body includes at least one body alignment element adapted to aligning the first body to an alignment body during an assembly of the ferrule. The ferrule includes a second body adapted to being arranged on the first body closing the longitudinal recess of the first body.

The advantage is that by aligning the first body with respect to the alignment body a high precision is enabled for aligning at least one wave guide ribbon with respect to the first body of the ferrule without the need that the first body and the at least one wave guide ribbon must be manufactured with high accuracy to automatically align to each other. The first body can thus be manufactured with low cost. Further, a simple assembly of the ferrule is possible and a high precision can be achieved reliably.

Preferably, the first and the second body of the ferrule are designed such that the at least one wave guide ribbon inserted into the longitudinal recess of the first body is fixed with respect to the ferrule between the first and the second body, for example by clamping.

According to a preferred embodiment of the second aspect, the first body includes at least two holes as body alignment elements, each being adapted to receive during an assembly of the ferrule one of at least two corresponding ferrule alignment pins protruding perpendicularly from an assembly surface of the alignment body. The advantage is that this is simple and that the first body can be easily manufactured with high accuracy and low cost. Further, this enables alignment with high precision.

According to a further preferred embodiment of the second aspect, the first body includes at least one longitudinal groove as a body alignment element, each being adapted to receive during an assembly of the ferrule one of at least one corresponding ferrule alignment rail arranged on an assembly surface of the alignment body. The advantage is that this is simple and that the first body can be easily manufactured with high accuracy and low cost. Further, this enables alignment with high precision.

According to a further preferred embodiment of the second aspect, at least one side groove is arranged in both side walls of the longitudinal recess of the first body, respectively, extending from a top edge of the respective side wall to at least a bottom edge of the respective side wall. By this, an adhesive can be filled into the side groove at the top edge, for example glue, and the adhesive can distribute through the side groove to the bottom edge fixing the at least one wave guide ribbon in the longitudinal recess of the first body when the adhesive is cured. The advantage is that this is simple and that the first body can be manufactured easily. Alternative to using adhesive, the at least one wave guide ribbon can be fixed in the longitudinal recess of the first body by another fixing method, for example soldering.

According to a further preferred embodiment of the second aspect, the second body includes at least one adhesive hole on each side of the longitudinal recess of the first body with respect to an assembled state of the ferrule. At least one longitudinal channel is arranged in the first and/or the second body in a contact surface of the first and the second body alongside the longitudinal recess of the first body with respect to an assembled state of the ferrule such that the respective adhesive hole is connected with the corresponding at least one longitudinal channel allowing adhesive inserted into the respective adhesive hole to distribute along the corresponding at least one longitudinal channel. By this, adhesive, such as glue, can be filled into the holes of the second body and the adhesive can flow through the hole into the at least one longitudinal groove and along the at least one longitudinal groove fixing the second body to the first body when the adhesive is cured. The advantage is that this is simple and that the first and the second body of the ferrule can be manufactured easily. Alternatively to using the adhesive the second body can be fixed to the first body by another fixing method, for example soldering.

According to a further preferred embodiment of the second aspect, the first and/or the second body includes a pin hole on each side of the longitudinal recess of the first body with respect to an assembled state of the ferrule. A respective position of the pin holes corresponds to a position of a corresponding ribbon alignment pin protruding perpendicularly from an assembly surface of the alignment body during assembly of the ferrule and used for aligning at least one wave guide ribbon to the alignment body when inserting the at least one wave guide ribbon into the longitudinal recess of the first body. The pin holes each are adapted to receive a fixing element for fixing a position of the at least one wave guide ribbon in the longitudinal recess of the first body. By this, the position of the at least one wave guide ribbon can be fixed reliably with respect to the first body. The advantage is that this is simple and that the first and second body can be manufactured easily.

A third aspect of the invention provides a wave guide ribbon. The wave guide ribbon includes at least one optical wave guide arranged longitudinally in the wave guide ribbon. The wave guide ribbon further includes at least one body alignment element for aligning the wave guide ribbon to an alignment body during assembly of a ferrule for an optical wave guide connector. The at least one optical wave guide is arranged at a predetermined position with respect to the at least one body alignment element. The advantage is that this allows for precise positioning of the at least one optical wave guide with respect to the ferrule. The assembly of the ferrule can thus be simple and reliable.

According to a preferred embodiment of the third aspect, at least two body alignment elements each are designed as holes in flanges of the wave guide ribbon, each being adapted to receive during an assembly of the ferrule corresponding ribbon alignment pins protruding perpendicularly from an assembly surface of the alignment body. The advantage is that this is simple and that the wave guide ribbon can be manufactured very precisely.

According to a further preferred embodiment of the third aspect, at least two optical wave guides are arranged in parallel in the wave guide ribbon in a first predetermined interval in a plane of the wave guide ribbon. By this, a high density of optical wave guides is possible. It further allows for arranging two or more optical wave guides easily and very precisely during assembly in a single step.

According to a further preferred embodiment of the third aspect, the wave guide ribbon has a predetermined thickness such that optical wave guides of at least two wave guide ribbons arranged directly above one another are arranged in a second predetermined interval perpendicular to a plane of the wave guide ribbon. By this, a high density of optical wave guides is possible. It further allows for arranging optical wave guides easily and very precisely during assembly.

A fourth aspect of the invention provides a tool for assembling a ferrule for an optical wave guide connector. The tool includes at least one alignment body with an assembly surface. The tool further includes at least one ferrule alignment element arranged on the assembly surface for aligning the ferrule with respect to the at least one alignment body. The tool further includes at least one ribbon alignment element arranged on the assembly surface for aligning at least one wave guide ribbon with respect to the at least one alignment body.

The advantage is that this tool is simple and can be manufactured very precisely for precisely arranging at least one wave guide ribbon with respect to the ferrule. In case the ferrule is designed for an MT optical fiber connector, the advantage is that by this the at least one wave guide ribbon can also be arranged very precisely with respect to MT-adapter alignment holes or pins of the ferrule. The tool can be used for assembling many ferrules. It allows for simple and precise assembly of the ferrules. It is particularly advantageous that two or more wave guide ribbons can be aligned to each other and with respect to the ferrule and, if applicable, to the MT-adapter alignment holes or pins very precisely. A precision in the order of magnitude of ±5 μm or better can be achieved reliably.

According to a preferred embodiment of the fourth aspect, the tool includes at least two ferrule alignment elements designed as ferrule alignment pins protruding perpendicularly from the assembly surface of the at least one alignment body.

According to a further preferred embodiment of the fourth aspect, the at least one ferrule alignment element is designed as a ferrule alignment rail. The advantage is that this is simple and the first body of the ferrule can be arranged on the assembly surface during assembly very precisely and manufactured easily with low cost.

According to a further preferred embodiment of the fourth aspect, the at least two ribbon alignment elements are designed as ribbon alignment pins protruding perpendicularly from the assembly surface of the alignment body. The advantage is that this is simple. The wave guide ribbon can be aligned precisely to the alignment body and thus also to the ferrule.

According to a further preferred embodiment of the fourth aspect, the tool includes a spacer body being adapted to be arranged on the assembly surface of the alignment body at a front face of the ferrule. The spacer body has a height equaling a height of the ferrule within a longitudinal recess of the ferrule with respect to the assembly surface of the alignment body. The advantage is that this is simple and that a high precision is possible. The spacer body stabilizes the at least one wave guide ribbon outside of the ferrule during assembly.

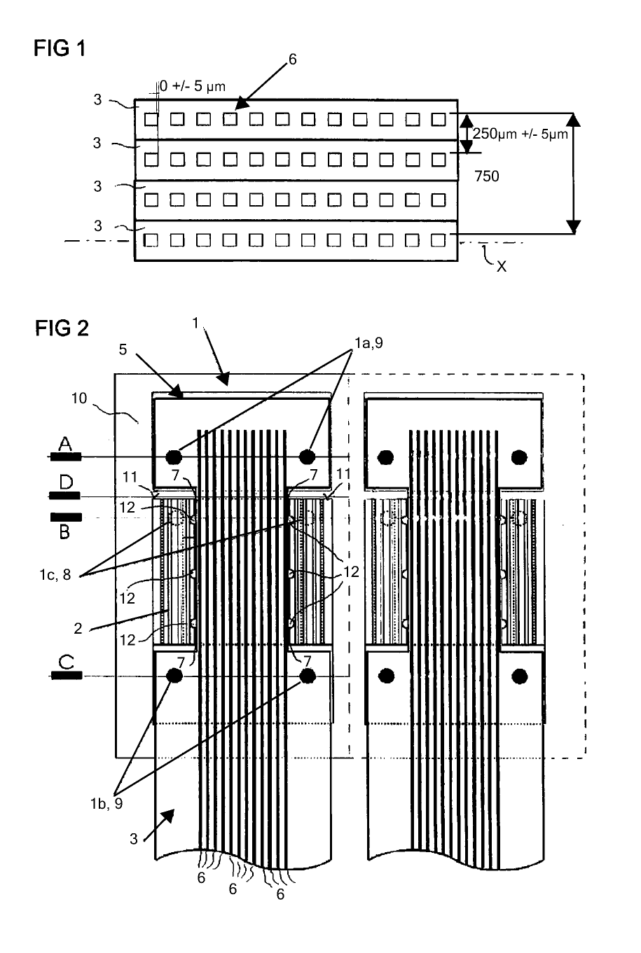

FIG. 1 shows a lateral cut through four wave guide ribbons 3 arranged directly above one another. Each wave guide ribbon 3 includes twelve optical wave guides 6. The optical wave guides 6 within each wave guide ribbon 3 are arranged longitudinally and in parallel to each other in a plane X of the respective wave guide ribbon 3 at a predetermined first interval. This predetermined first interval can, for example, amount to 250 μm, preferably with a precision of ±5 μm or better. The predetermined first interval and/or the precision can alternatively be greater or less than 250 μm and 5 μm, respectively. Further, each wave guide ribbon 3 can include more or less than twelve optical wave guides 6.

Preferably, the wave guide ribbons 3 are provided with the same predetermined thickness that, for example, amounts to 250 μm with a high precision of preferably ±1 μm. Thus, optical wave guides 6 in different wave guide ribbons 3 arranged directly above one another are automatically arranged at a predetermined second interval in a direction perpendicular to the plane X. This predetermined second interval can, for example, amount to 250 μm, preferably with a precision of ±5 μm or better. The predetermined second interval and/or the precision can alternatively be greater or less than 250 μm and 5 μm, respectively. Further, a position of each optical wave guide 6 in the respective wave guide ribbons 3 perpendicular to the plane X has a precision of preferably ±5 μm or better.

The optical wave guides 6 preferably are plastic optical fibers. The wave guide ribbons 3 can thus be easy to handle and cheap to manufacture. The optical wave guides 6 can alternatively be made of another material, for example glass. The wave guide ribbons 3 preferably are flexible.

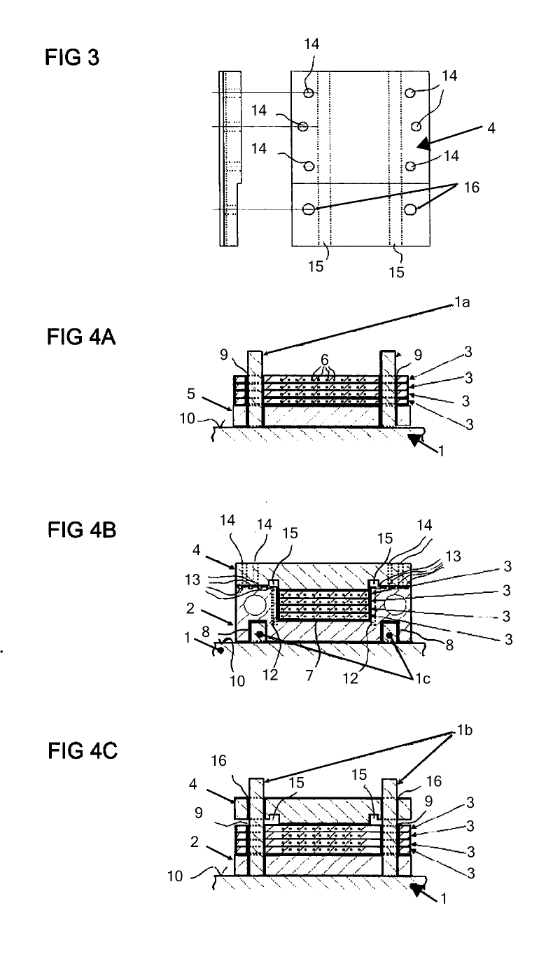

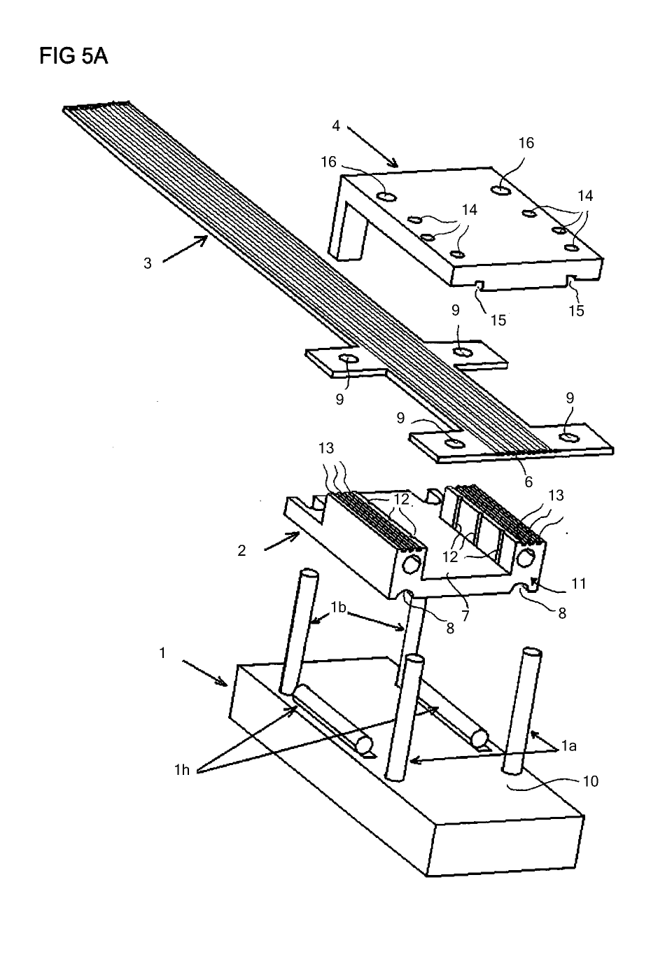

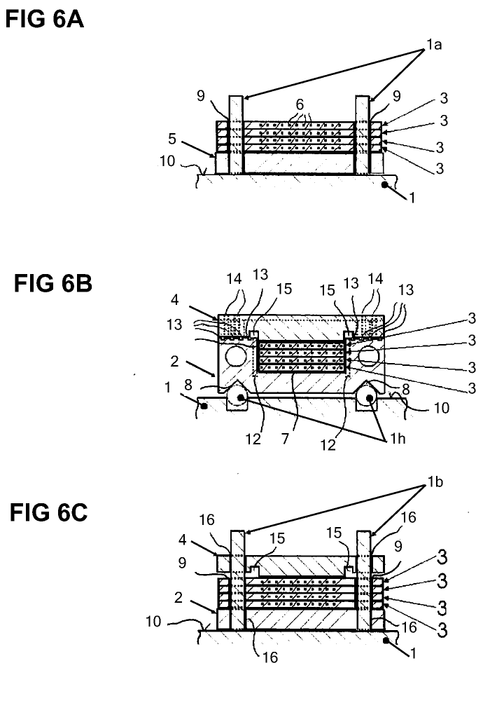

FIG. 2 shows a top view of a tool for assembling two ferrules for optical wave guide connectors in parallel with ferrules according to a first embodiment during assembly. The tool can alternatively be designed for assembling more than two ferrules in parallel or for assembling just one ferrule at a time. The ferrules in their assembled state preferably have outer dimensions compliant with an MT optical fiber connector known in the art. The tool includes an alignment body 1 with an assembly surface 10 and at least one ribbon alignment element 1a, 1b and at least one ferrule alignment element 1c, 1h. Ferrule alignment element 1h is not shown in FIG. 2 but is shown first in FIG. 5A. The tool preferably further includes a spacer body 5 adapted to be arranged on the assembly surface 10 to stabilize at least one wave guide ribbon 3 during assembly of the ferrule. Usage of the spacer body 5 is optional. Each ferrule includes a first body 2 and a second body 4. FIG. 2 shows the ferrule in a state of the assembly in which the second body 4 is not yet mounted. The second body 4 according to the first embodiment is shown separately in FIG. 3 in a top view and a side view. During assembly, the spacer body 5 is arranged on the assembly surface 10 at a front face 11 of the first body 2 and thus at a front face of the ferrule.

The first body 2 of the ferrule includes a longitudinal recess 7 adapted to receive at least one wave guide ribbon 3 during assembly. The first body 2 further includes at least one body alignment element 8. The at least one body alignment element 8 is adapted to fit to the corresponding ferrule alignment element 1c, 1h of the tool such that the first body 2 of the ferrule is aligned precisely to the alignment body 1 of the tool when the at least one body alignment element 8 and the respectively corresponding ferrule alignment element 1c, 1h are brought together during assembly. The second body 4 is used to close the longitudinal recess 7 of the first body 2 and preferably to fix at least one wave guide ribbon 3 within the longitudinal recess 7 of the first body 2, for example by clamping. Preferably, the first body 2 and second body 4 and particularly the longitudinal recess 7 are designed and dimensioned such that, in a closed or assembled state of the ferrule, a space within the longitudinal recess 7 between a bottom of the longitudinal recess 7 and the second body 4 as a ceiling essentially is as high as a height of the at least one wave guide ribbon 3, stacked above one another if applicable, being arranged or to be arranged within the longitudinal recess 7. This space can alternatively be dimensioned less or greater than that. The second body 4 is fixed to the first body 2 during assembly. The spacer body 5 preferably has a thickness equal to a thickness of the first body 2 of the ferrule within the longitudinal recess 7. By this, the spacer body 5 can prevent bending of the at least one wave guide ribbon 3 outside the ferrule during assembly and thus can prevent damage of the at least one wave guide ribbon 3 and enhance the precision of the positioning of the at least one wave guide ribbon 3 with respect to the ferrule.

The wave guide ribbons 3 each comprise at least one body alignment element 9. The at least one body alignment element 9 is adapted to fit to the corresponding ribbon alignment element 1a, 1b of the tool such that the respective wave guide ribbon 3 is aligned precisely to the alignment body 1 of the tool when the at least one body alignment element 9 and the respectively corresponding ribbon alignment element 1a, 1b are brought together during assembly. By this, the wave guide ribbons 3 can be aligned very precisely to the ferrule and particularly to the first body 2 of the ferrule. U.S. Pat. No. 7,212,698 discloses a method making use of fiducials that can be used to precisely manufacture the at least one body alignment element 9 of the respective wave guide ribbon 3. U.S. Pat. No. 7,212,698 is herein incorporated by reference.

FIG. 3 shows a top view and side view of the second body 4. The second body 4 includes at least one adhesive hole 14 at each side of the longitudinal recess 7 with respect to the assembled state of the ferrule. Preferably, the second body 4 includes a longitudinal groove 15 at each side. The second body 4 can also includes pin holes 16 to receive the respectively corresponding ribbon alignment pins of the alignment body 1 during assembly of the ferrule.

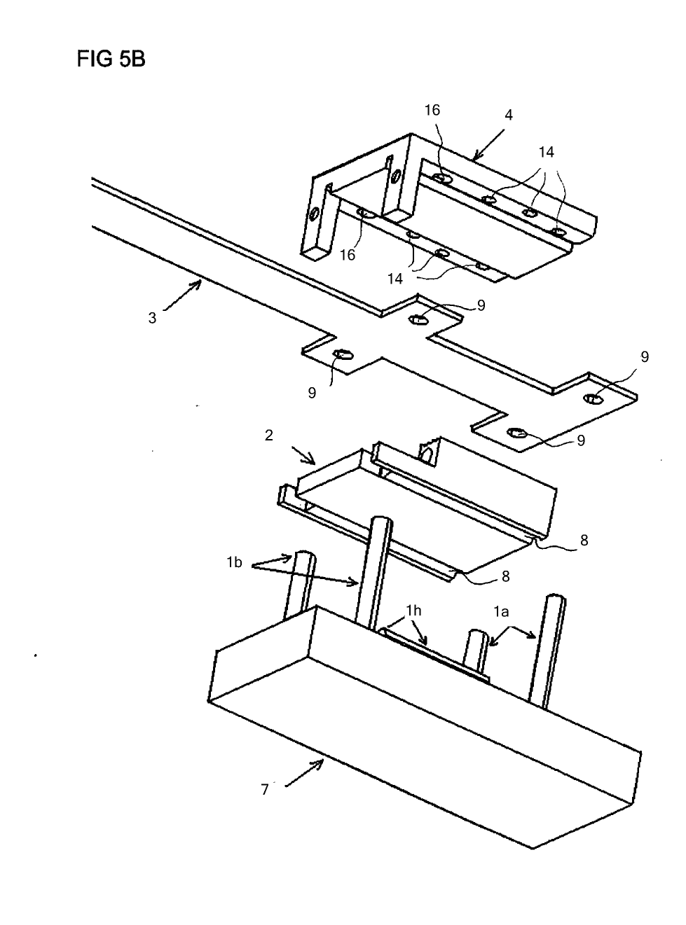

FIGS. 4A, 4B and 4C show lateral cuts through the tool, the ferrule and four wave guide ribbons 3 according to the first embodiment and according to the positions of the lateral cuts A, B and C, respectively, shown in FIG. 2. In FIGS. 4A, 4B and 4C the second body 4 of the ferrule is mounted. In the first embodiment, the respective ferrule alignment element 1c of the alignment body 1 is designed as a ferrule alignment pin extending perpendicularly from the assembly surface 10 of the alignment body 1. The respective body alignment element 8 of the first body 2 of the ferrule is designed as a hole adapted to precisely receive the corresponding ferrule alignment pin during assembly of the ferrule. By bringing together the body alignment elements 8 with the corresponding ferrule alignment pin the first body 2, the ferrule is precisely aligned to the alignment body 1.

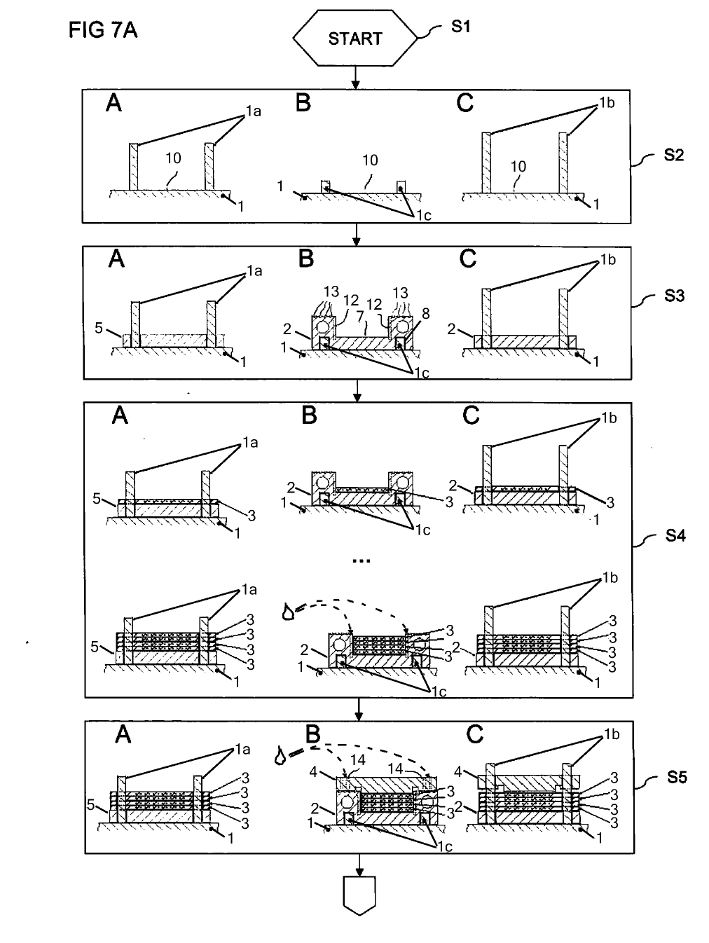

FIGS. 5A and 5B show exploded views of a second embodiment from two different viewpoints. FIGS. 6A, 6B and 6C show lateral cuts through the tool, the ferrule and four wave guide ribbons 3 according to the second embodiment and according to the positions of the lateral cuts A, B and C, respectively, shown in FIG. 2. The second embodiment essentially differs from the first embodiment in that the ferrule alignment elements 1h of the alignment body 1 are designed as respective ferrule alignment rail and in that the corresponding body alignment element 8 of the first body 2 of the ferrule is designed as a respective longitudinal groove fitting on the respectively corresponding ferrule alignment rail of the alignment body 1. The respective longitudinal groove can be designed with a triangle profile and the respective ferrule alignment rail can be design with a cylindrical profile as shown in FIG. 6B. However, the respective longitudinal groove and/or the respective ferrule alignment rail can alternatively be designed differently.

The body alignment elements 8 and the ferrule alignment elements 1h according to the second embodiment enable a precise alignment of the ferrule with respect to the alignment body 1 in a direction perpendicular to a longitudinal axis of the longitudinal grooves and the ferrule alignment rails and parallel to the assembly surface 10. An advantage is that high precision is only required with respect to this one direction. Preferably, the wave guide ribbons 3 are cut at the front face 11, shown in FIG. 2 and FIG. 5A, of the ferrule after assembly. A longitudinal alignment of the ferrule with respect to the alignment body 1 is then not required. The ferrule and particularly the first body 2 of the ferrule can thus be manufactured with low cost.

The ribbon alignment elements 1a, 1b of the alignment body 1 preferably are designed as ribbon alignment pins arranged perpendicularly on the assembly surface 10 of the alignment body 1. Correspondingly, the body alignment elements 9 of each wave guide ribbon 3 are designed as holes cut very precisely into a respective flange of the respective wave guide ribbon 3. A precision of a position of the respective hole, that is body alignment element 9, preferably is in an order of magnitude of 1 μm. Particularly, the optical wave guides 6 of the respective wave guide ribbon 3 each have a predetermined position with respect to the body alignment elements 9 with high accuracy. By bringing together the body alignment elements 9 with the respectively corresponding ribbon alignment pin the at least one wave guide ribbon 3 and its at least one optical wave guide 6 are precisely aligned to the alignment body 1. The first and/or second body 2, 4 can also comprise pin holes 16 to receive the respectively corresponding ribbon alignment pins of the alignment body 1 during assembly of the ferrule.

Preferably, the at least one wave guide ribbon 3 is held within the longitudinal recess 7 of the first body 2 of the ferrule after assembly of the ferrule by clamping between the first and the second body 2, 4 of the ferrule. It can be advantageous, though, to use an adhesive or another fixing method, for example soldering, to permanently fix the at least one wave guide ribbon 3 within the longitudinal recess 7. The adhesive can be provided as a coating on at least part of the respective wave guide ribbon 3. The adhesive or other fixing method can be used during assembly to fix the at least one wave guide ribbon 3 to the first body 2 of the ferrule. Preferably, the first body 2 includes at least one side groove 12 in each side wall of the longitudinal recess 7. Each side groove 12 preferably extends from a top edge of the respective side wall to at least a bottom edge of the respective side wall. This enables adhesive to fill into each side groove 12 at the top edge preferably after all wave guide ribbons 3 have been arranged in the longitudinal recess 7. The adhesive can then distribute through the side groove 12 to the bottom edge wetting a border of each wave guide ribbon 3. By this, the at least one wave guide ribbon 3 can be fixed to the first body 2 after curing the adhesive. Preferably, the adhesive does not flow too easily in order to avoid leakage in between wave guide ribbons 3. Further, an amount of adhesive used should be such that it is sufficient to fix the wave guide ribbons 3 but that no bump is formed on top of the wave guide ribbons 3. This enables high precision and a robust ferrule.

Preferably, at least one longitudinal channel 13 is arranged in the first and/or second body 2, 4 of the ferrule at a contact surface of the first and the second body 2, 4 at each side of the longitudinal recess 7 with respect to the assembled state of the ferrule. Further, the second body 4 includes at least one adhesive hole 14 at each side of the longitudinal recess 7 with respect to the assembled state of the ferrule. In the assembled state of the ferrule, the respective adhesive hole 14 can is positioned adjacent the respectively corresponding longitudinal channel 13. By this, an adhesive filled into each adhesive hole 14 can flow into the at least one respectively corresponding longitudinal channel 13 and distribute along it. By this, the first and second body 2, 4 of the ferrule can be bonded together and fixed to each other after curing the adhesive. Further, a high precision is possible, because the adhesive cannot flow in between the first and the second body 2, 4 to lift the second body 4 from the first body 2.

Preferably, the second body 4 includes a longitudinal groove 15 at each side in a position such that the respective longitudinal groove 15 can align with the at least one side groove 12 in the side wall of the longitudinal recess 7 of the first body 2 in the assembled state of the ferrule. The advantage is that the respective longitudinal groove 15 can absorb excessive adhesive and thus can help to avoid the creation of a bump of adhesive in the ferrule and particularly can help to avoid adhesive to leek in between the top wave guide ribbon 3 and the second body 4. The ferrule can thus be assembled very precisely. The longitudinal grooves 15 can also be designed and located such that alignment with at least one of the longitudinal channels 13 is possible to also absorb excessive adhesive from there. Alternatively to using the adhesive the first and second body 2, 4 can be bonded together by another fixing method, for example soldering.

To further enhance the robustness of the ferrule after assembly and to better fix the position of the at least one wave guide ribbon 3 with respect to the first and second body 2, 4 of the ferrule, a respective fixing element 17 can be provided to the ferrule. The fixing element 17 preferably is designed as a nail-like pin which can be inserted into the pin holes 16 of the first and/or second body 2, 4 of the ferrule and the respectively corresponding body alignment elements 9 of the at least one wave guide ribbon 3 arranged in the ferrule after the ferrule has been taken from the alignment body 1. The fixing elements 17 can thus replace ribbon alignment pins of the alignment body 1 after the ferrule has been taken from the alignment body 1.

The ferrules with the first and the second body 2, 4 and the tool according to the first and to the second embodiment and the wave guide ribbon 3 shown in the figures are examples and can be designed differently.

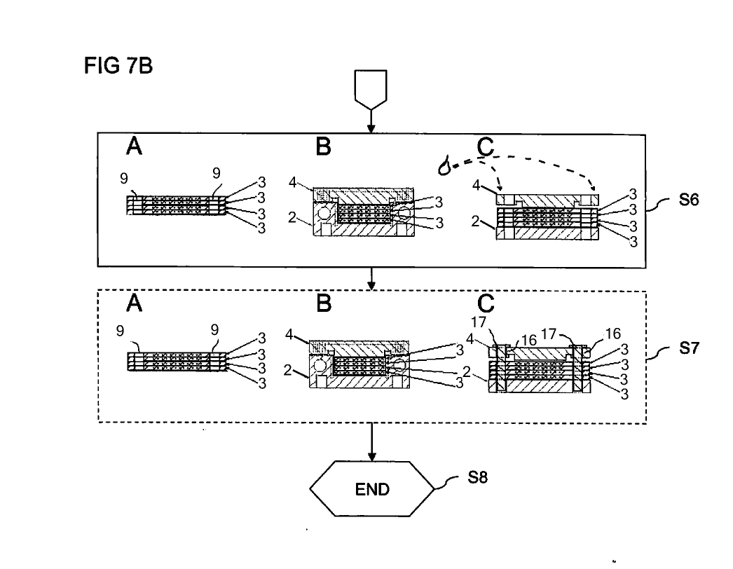

FIGS. 7A and 7B show a flow diagram of the assembly of the ferrule. The assembly is shown as an example with the first embodiment. The assembly can alternatively be performed accordingly with the second embodiment. In the flow diagram, the lateral cuts A, B and C with positions according to FIG. 2 are shown side by side in each step.

The assembly starts with a step S1. In a step S2 the alignment body 1 is provided. In a step S3 the spacer body 5 and the first body 2 of the ferrule are arranged on the assembly surface 10 of the alignment body 1. The first body 2 is aligned to the alignment body 1 by bringing together the at least one body alignment element 8 of the first body 2 and the respectively corresponding ferrule alignment element 1c, 1h of the alignment body 1. The spacer body 5 and/or the first body 2 can include pin holes 16 for receiving the respectively corresponding ribbon alignment element 1a, 1b of the alignment body 1. The first body 2, in addition to the alignment via the body alignment elements 8 and the ferrule alignment elements 1c, 1h, can be aligned via the pin holes 16 in the first body 2 and the respectively corresponding ribbon alignment elements 1b.

In a step S4 at least one wave guide ribbon 3 and preferably at least two wave guide ribbons 3, for example four wave guide ribbons 3, are inserted into the longitudinal recess 7 of the first body 2 using the ribbon alignment elements 1a, 1b of the alignment body 1 for alignment. The respective wave guide ribbon 3 is aligned to the alignment body 1 by bringing together the at least one body alignment element 9 of the respective wave guide ribbon 3 and the respectively corresponding ribbon alignment element 1a, 1b of the alignment body 1. An adhesive or another fixing method can be provided to permanently fix the at least one wave guide ribbon 3 within the longitudinal recess 7 of the first body 2. Preferably, adhesive is filled into the at least one side groove 12 in each side wall of the longitudinal recess 7. Preferably, the adhesive is cured.

In a step S5 the second body 4 of the ferrule is provided and arranged on the first body 2 to close the longitudinal recess 7. Preferably, the second body 4 clamps the at least one wave guide ribbon 3 in the longitudinal recess 7 such that in the step S4 no adhesive is required. Preferably, the second body 4 is fixed to the first body 2, for example with an adhesive. Preferably, the adhesive is filled into adhesive holes 14 of the second body 4. Preferably, the adhesive distributes through the respective adhesive hole 14 into and along the at least one respectively corresponding longitudinal channel 13 of the first and/or second body 2, 4 such that after curing the adhesive the second body 4 is permanently and reliably fixed to the first body 2.

In a step S6 the ferrule with the at least one wave guide ribbon 3 is taken off the alignment body 1. An adhesive can be filled into pin holes 16 of the first and/or second body 2, 4 of the ferrule and body alignment elements 9 of the respective wave guide ribbon 3 corresponding with the pin holes 16. This allows for an alternative or additional fixing of at least one wave guide ribbon 3 and the ferrule. In an optional step S7, fixing elements 17, for example in the form of the nail-like pin, can be provided and inserted into the pin holes 16 and the respectively corresponding body alignment elements 9. Further, preferably the at least one wave guide ribbon 3 is cut at the front face 11. See position of lateral cut D in FIG. 2. The assembly ends in a step S8.

The steps of the assembly can performed in a different sequence. For example, instead of arranging the spacer body 5 on the assembly surface 10 in step 3 the spacer body 5 can alternatively be provided already arranged on the assembly surface 10 of the alignment body 1 in step S2. Further, the spacer body 5 can be designed as a permanent part of the alignment body 1 or can even be in one piece with the alignment body 1. Further, other fixing methods or materials can be used to fix the at least one wave guide ribbon 3 within the longitudinal recess 7 of the first body 2 and/or to fix the second body 4 to the first body 2 and/or to fix the fixing elements 17. The usage of the adhesive, for example glue, is therefore optional.

The tool, that is the alignment body 1 and preferably also the spacer body 5, are manufactured with a high precision, preferably in an order of magnitude of 1 μm. Particularly, a respective position and dimension of the ribbon alignment elements 1a, 1b and the ferrule alignment elements 1c, 1h is provided with high accuracy. This enables to very precisely align the first body 2 and the at least one wave guide ribbon 3 to the alignment body 1 and thus to very precisely align the at least one wave guide ribbon 3 to the first body 2 of the ferrule. This particularly enables stacking of two or more wave guide ribbons 3 with high precision such that the respective optical wave guides 6 are precisely positioned with respect to the ferrule. Optical wave guide connectors with two or more wave guide ribbons 3 and thus with a possibly high number of optical wave guides 6 can be assembled easily and reliably with high precision and low cost. The tool can be reused for assembling several ferrules. The first and the second body 2, 4 of the ferrule preferably are manufactured using injection molding. Particularly the first body 2 is manufactured with a high precision, preferably on an order of magnitude of 1 μm, particularly with respect to the body alignment elements 8.

What is claimed is:

1. A method of assembling a ferrule for an optical wave guide connector, the method comprising steps of:
aligning a first body of the ferrule with respect to an alignment body, wherein the first body includes a longitudinal recess adapted to receive at least one wave guide ribbon;
aligning at least one wave guide ribbon with respect to the alignment body;
inserting the at least one wave guide ribbon into the longitudinal recess of the first body; and
closing the longitudinal recess of the first body with a second body of the ferrule.

2. The method according to claim 1, wherein the step of aligning the first body of the ferrule to the alignment body is carried out by bringing together at least one ferrule alignment element included in the alignment body and a corresponding body alignment element included in the first body of the ferrule.

3. The method according to claim 1, wherein the step of aligning the at least one wave guide ribbon to the alignment body is carried out by bringing together at least one ribbon alignment element included in the alignment body and a corresponding body alignment element included in the at least one wave guide ribbon.

4. The method according to claim 1, wherein at least two wave guide ribbons are inserted into the longitudinal recess of the first body directly above one another.

5. The method according to claim 1, further comprising the step of arranging a spacer body on an assembly surface of the alignment body at a front face of the first body prior to inserting the at least one wave guide ribbon into the longitudinal recess of the first body, wherein the spacer body has a height equaling a height of the first body in the longitudinal recess with respect to the assembly surface of the alignment body.

6. A ferrule apparatus for an optical wave guide connector, the apparatus comprising:
a first body having a longitudinal recess and adapted to receive at least one wave guide ribbon and having at least one body alignment element adapted to align the first body to an alignment body; and
a second body adapted to arrange on the first body to close the longitudinal recess of the first body.

7. The ferrule apparatus according to claim 6, wherein the at least one body alignment element of the first body includes at least two holes adapted to receive at least two corresponding ferrule alignment pins protruding perpendicularly from an assembly surface of an alignment body.

8. The ferrule apparatus according to claim 6, wherein the at least one body alignment element of the first body includes at least one longitudinal groove adapted to receive at least one corresponding ferrule alignment rail arranged on an assembly surface of an alignment body.

9. The ferrule apparatus according to claim 6, wherein the longitudinal recess of the first body is adapted to include at least one side groove arranged in both side walls of the longitudinal recess and wherein the at least one side groove in both side walls extends from a top edge of the respective side wall to at least a bottom edge of the respective side wall.

10. The ferrule apparatus according to claim 6, wherein the second body is adapted to include at least one adhesive hole positioned on each side of the longitudinal recess of the first body with respect to an assembled state of the ferrule and wherein the first and/or the second body is adapted to include at least one longitudinal channel arranged in a contact surface on each side of the longitudinal recess of the first body with respect to an assembled state of the ferrule such that the at least one adhesive hole is positioned with respect to the at least one longitudinal channel to allow adhesive inserted into the at least one adhesive hole to distribute along the at least one longitudinal channel.

11. The ferrule apparatus according to claim 6, wherein the first and/or the second body is adapted to include a pin hole positioned on each side of the longitudinal recess of the first body with respect to an assembled state of the ferrule, a respective position of the pin holes corresponds to a position of a corresponding ribbon alignment pin protruding perpendicularly from an assembly surface of the alignment body during assembly of the ferrule and used for aligning at least one wave guide ribbon to the alignment body when inserting the at least one wave guide ribbon into the longitudinal recess of the first body, the pin holes each being adapted to receive a fixing element for fixing a position of the at least one wave guide ribbon in the longitudinal recess of the first body.

12. A wave guide ribbon, comprising:
at least one optical wave guide arranged longitudinally in the wave guide ribbon; and
at least one body alignment element for aligning the wave guide ribbon to an alignment body during assembly of a ferrule for an optical wave guide connector;
wherein the at least one optical wave guide is arranged at a predetermined position with respect to the at least one body alignment element.

13. The wave guide ribbon according to claim 12, wherein the at least one body alignment element is a hole in a flange of the wave guide ribbon and is adapted to receive a corresponding ribbon alignment pin protruding perpendicularly from an assembly surface of the alignment body.

14. The wave guide ribbon according claim 12, wherein at least two optical wave guides are arranged in parallel in the wave guide ribbon in a first predetermined interval in a plane of the wave guide ribbon.

15. The wave guide ribbon according to claim 12, wherein the wave guide ribbon has a predetermined thickness such that at least two wave guide ribbons can be assembled within the ferrule.

16. A tool for assembling a ferrule for an optical wave guide connector, the tool comprising:
at least one alignment body having an assembly surface;
at least one ferrule alignment element arranged on the assembly surface for aligning the ferrule with respect to the at least one alignment body;
at least one ribbon alignment element arranged on the assembly surface for aligning at least one wave guide ribbon with the at least one alignment body.

17. The tool according to claim 16, wherein the at least one ferrule alignment element is a ferrule alignment pin protruding perpendicularly from the assembly surface of the at least one alignment body.

18. The tool according to claim 16, wherein the at least one ferrule alignment element is a ferrule alignment rail.

19. The tool according to claim 16, wherein the at least one ribbon alignment element is a ribbon alignment pin protruding perpendicularly from the assembly surface of the alignment body.

20. The tool according to claim 16, further comprising a spacer body adapted to be arranged on the assembly surface of the alignment body at a front face of the ferrule, wherein the spacer body has a height equaling a height of the ferrule within a longitudinal recess of the ferrule with respect to the assembly surface of the alignment body.
